(19) United States
(12) Patent Application Publication
(10) Pub. No.: US 2008/0309238 A1
(43) Pub. Date: Dec. 18, 2008

(54) Plasma Producing Device Comprising Magnesium Oxide Microparticles Having Specific Cathodoluminescence Characteristics

(75) Inventors: Mansoo CHOI, Seoul (KR); Chang Hyuk Kim, Seoul (KR); Seungha Shin, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Seoul National University Industry Foundation, Seoul (KR)

(21) Appl. No.: 12/024,407

(22) Filed: Feb. 1, 2008

(30) Foreign Application Priority Data
Jun. 15, 2007 (KR) 10-2007-0059077

(51) Int. Cl. H01J 17/49

(52) U.S. Cl. 313/587

(57) ABSTRACT

A plasma producing device of the present invention comprising magnesium oxide (MgO) microparticles whose cathodoluminescence emission shows no peak at around a wavelength of 300 nm or less, but exhibits a peak at a wavelength in the range of 350 to 500 nm as well as at least one peak at wavelengths in the ranges of 550 to 650 nm and 700 to 800 nm upon excitation by an electron beam exhibits improved discharge characteristics.

This is a Utility Application filed on Feb. 1, 2008, which claims benefit from Korean Patent Application 10-2007-0059077 filed Jun. 15, 2007, which is incorporated herein by reference.

### FIELD OF THE INVENTION

The present invention relates to a plasma producing device comprising magnesium oxide (MgO) microparticles having specific cathodoluminescence characteristics.

### BACKGROUND OF THE INVENTION

A general plasma display panel (PDP), schematically illustrated in FIG. 1, consists of a first substrate 1; at least one first electrode 2 disposed on the surface of the first substrate 1; a first dielectric layer 3 formed on the surface of the first substrate 1 enveloping the first electrode 2; a second substrate 8; at least one second electrode 9 disposed on the surface of the second substrate 8; a second dielectric layer 6 formed on the surface of the second substrate 8 covering the second electrode 9; MgO protective layer 4 disposed on the surface of the first dielectric layer 6; partitions 5 positioned between the first and second substrates defining a discharge space between the first and second substrates; and a phosphor layer 7 deposited in the discharge space.

Recently, the characteristics of MgO have been widely studied because of the recognition that they play an important role in improving the efficiency of PDP. For example, there have been reports that high secondary electron emission (SEE) of MgO would may improve the discharge characteristics by reducing the discharge voltage (see [H. S. Uhm, E. H. Choi, and J. Y. Lim, Applied Physics Letters, 78(5), 592-594, 2001]), and that an increased level of oxygen defects in MgO may increase the secondary electron emission (see [Y. Motoyama, Y. Hirano, K. Ishii, Y, Murakami, and F. Sato, Journal of Applied Physics, 95(12) 8419-8424, 2004]).

Accordingly, there has been a need to develop MgO microparticles having a high content of oxygen defects, which is capable of improving the discharge characteristics of the plasma producing device.

### SUMMARY OF THE INVENTION

Accordingly, it is an object of the present invention to provide a plasma producing device comprising magnesium oxide (MgO) microparticles having a high level of oxygen defects, which exhibits improved discharge characteristics in terms of low discharge voltage and short delay time.

In accordance with one aspect of the present invention, there is provided a plasma producing device comprising:

a first substrate;

at least one first electrode disposed on the surface of the first substrate;

a first dielectric layer formed on the surface of the first substrate, in which the first electrode is embedded;

a second substrate;

at least one second electrode disposed on the surface of the second substrate;

a second dielectric layer formed on the surface of the second substrate, in which the second electrode is embedded; and

partitions positioned between the first and second substrates defining a discharge space between the first and second substrates,

wherein the discharge space comprises magnesium oxide (MgO) microparticles whose cathodoluminescence emission shows no peak at a wavelength of 300 nm or less, but exhibits a peak at a wavelength in the range of 350 to 500 nm as well as at least one peak at wavelengths in the ranges of 550 to 650 nm and 700 to 800 nm when excited by an electron beam.

### BRIEF DESCRIPTION OF THE DRAWINGS

The above and other objects and features of the present invention will become apparent from the following description of the invention, when taken in conjunction with the accompanying drawings:

FIG. 1: a schematic view of a conventional plasma display panel (PDP);

FIG. 2: a schematic view of PDP comprising a magnesium oxide (MgO) microparticle layer, according to one embodiment of the present invention;

FIG. 3: a sectional view of the PDP comprising MgO microparticle layer in FIG. 2;

FIG. 4: a scanning electron microscopy (SEM) photograph of the MgO microparticle having thickness ranging from 500 nm to 700 nm coated on a protective MgO layer (Example 2);

FIG. 5: a schematic view showing the process for preparing the inventive MgO microparticles;

FIGS. 6A and 6B: X-ray diffraction (XRD) scans of the MgO microparticles obtained in Examples containing trace amounts of manganese (Mn);

FIGS. 7A and 7B: electron spin resonance spectrometer (ESR) results obtained for the MgO microparticles containing trace amounts of Mn obtained in Examples;

FIGS. 8A and 8B: SEM photographs of the MgO microparticles containing trace amounts of Mn obtained in Examples;

FIGS. 9A and 9B: transmission electron microscopy (TEM) photographs of the MgO microparticles containing trace amounts of Mn obtained in Examples;

FIGS. 10A and 10B: cathodoluminescence (CL) scans obtained for the magnesium oxide microparticles containing trace amounts of Mn obtained in Examples;

FIG. 11: energy-dispersive X-ray spectroscopy (EDX or EDS) results obtained for the MgO microparticles containing trace amounts of Mn obtained in Examples;

FIG. 12: the delay times of discharge cells with and without the inventive MgO microparticles containing 14 ppm of Mn; and

FIG. 13: the discharge voltages of discharge cells with and without the inventive MgO microparticles containing 14 ppm of Mn.

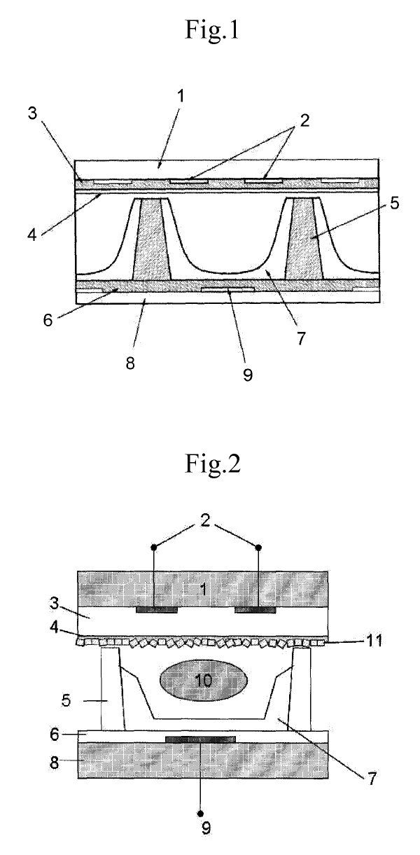

### BRIEF DESCRIPTION OF THE REFERENCE NUMERALS IN DRAWINGS

| | |
|---|---|
| 1: first substrate | |
| 2: first electrode (row electrodes (X, Y)) | |
| 3: first dielectric layer | 4: MgO protective layer |
| 5: partitions | 6: second dielectric layer |
| 7: phosphor layer | 8: second substrate |
| 9: second electrode (address electrode) | |
| 10: plasma | |
| 11: MgO microparticle layer having specific | |
| cathodoluminescence characteristics | |

### DETAILED DESCRIPTION OF THE INVENTION

The present invention is characterized in that a plasma producing device, especially plasma display panel (PDP), comprises magnesium oxide (MgO) microparticles whose cathodoluminescence emission shows no peak at a wavelength of 300 nm or less, but exhibits a peak at a wavelength in the range of 350 to 500 nm as well as at least one peak at wavelengths in the range of 550 to 650 nm and 700 to 800 nm, said MgO microparticles being disposed in the discharge space between the first substrate and the second substrate.

The MgO microparticles having the specific cathodoluminescence characteristics according to the present invention can be prepared by combusting an Mg powder or a magnesium compound; or a mixture of an Mn powder or a manganese compound and an Mg powder or a magnesium compound under an oxygen atmosphere. For example, an Mg powder or an Mg-containing compound is subjected to combustion using a flame at a temperature ranging from 700 to 2200° C. to generate spontaneous combustion, followed by burning the combustion product under an oxygen atmosphere.

The MgO microparticles thus obtained may contain 1 to 1000 ppm of Mn. The Mn-containing compound used in the present invention can be manganese chloride or a manganese organic compound such as Mn[C₅H₇O₂]₂, and the Mg-containing compound used in the present invention can be MgCl₂ or a magnesium organic compound such as Mg[C₅H₇O₂]₂, but is not limited thereto.

The amount of Mn contained in the metal mixture can be adjusted by changing the Mg to Mn mix ratio in the starting material.

The MgO microparticles thus obtained contain a trace amount of Mn ion (Mn²⁺) and have a cubic crystal structure and an average diameter ranging from several nm to several μm, preferably from 5 nm to 5 μm, whose cathodoluminescence emission shows no peak at a wavelength of 300 nm or less, but exhibits a peak at a wavelength in the range of 350 to 500 nm and at least one peak at a wavelengths in the ranges of 550 to 650 nm and 700 to 800 nm.

In accordance with the present invention, the intensity of the emission peak can be adjusted by varying the Mn content, and the amounts of oxygen defects generated in the MgO microparticles can be adjusted by varying the oxygen ratio.

FIG. 2 schematically illustrates a PDP comprising MgO microparticles, according to one embodiment of the present invention. Specifically, the PDP comprises at least a pair of parallely arranged first electrodes (row electrodes (X, Y)) 2 on the surface of the first substrate 1 serving as a display surface, and the electrode pair (X, Y) extends in line with the first substrate 1. A first dielectric layer 3 is formed on the surface of the first substrate 1, in which the first electrode pair (X, Y) 2 is embedded.

MgO protective layer 4 is formed between the first dielectric layer 3 and the layer of the MgO microparticles 11 by deposition or sputtering.

A second substrate 8 is positioned and parallel to the first substrate 1 with a discharge space interposed therebetween.

At least one second electrode (address electrode) 9 is placed on the surface of the second substrate 8, and a second dielectric layer 6 is formed on the surface of the second substrate 8, in which the second electrode 9 is embedded.

Partitions 5 are disposed in the discharge space between the first and second substrates, and a phosphor layer 7 is formed to cover the side faces of the transverse walls, the vertical walls of the partitions 5 and the surface of the second dielectric layer 6. Discharge cells comprising the phosphor layer 7 with the three primary colors are arranged in the order of the red, green and blue in the transverse direction.

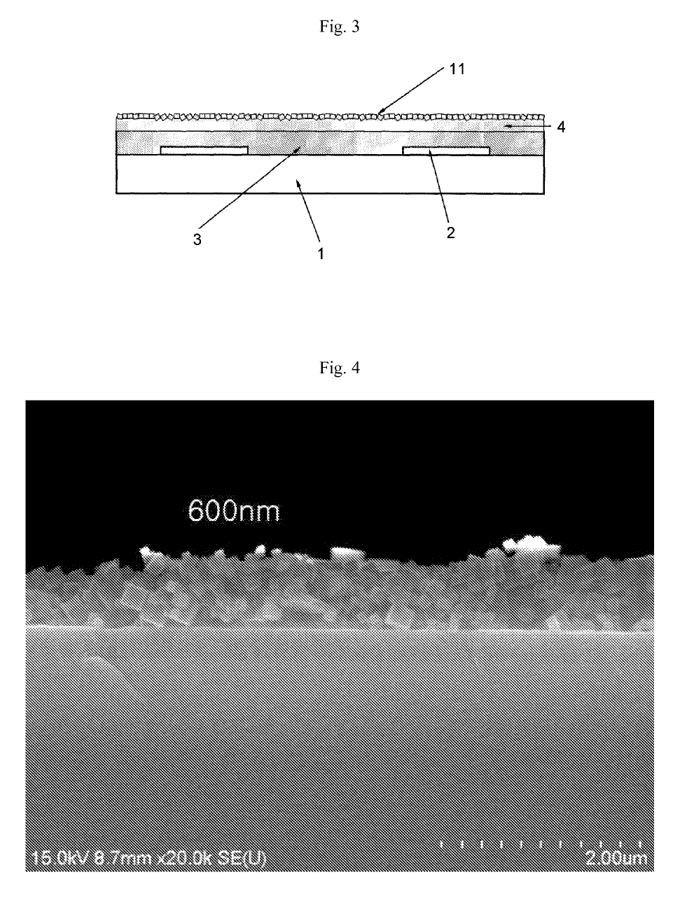

The inventive MgO microparticles having the above-mentioned cathodoluminescence emission characteristics can be desposed on the surface of the first dielectric layer 3, or optionally on the surface of the MgO protective layer 4 or on the surface of the phosphor layer 7 in the form of a layer (e.g. MgO layer 11, in FIG. 3).

The MgO layer 11 may be formed by coating or laminating by a conventional spraying process, electrostatic coating process, screen printing process, offset process, dispenser process, ink-jet process or roll coating process to a thickness ranging from 100 to 2000 nm.

Alternatively, the MgO microparticles may be embedded in the phosphor layer 7.

The following Examples are intended to further illustrate the present invention without limiting its scope.

### <Preparation of Magnesium Oxide (MgO) Microparticles>

### EXAMPLE 1

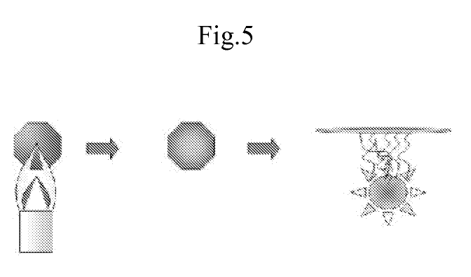

As shown in FIG. 5, a magnesium metal powder (average diameter: less than 45 μm, purity: 99.98%, Samchun chemical Co.) containing a trace amount of Mn was compressed into a pellet, and heated using hydrogen-oxygen diffusion flame (700 to 2,200° C.) to induce spontaneous combustion of the Mg powder. When the spontaneous combustion started, the combusted material was exposed to an oxygen atmosphere, and MgO microparticles generated were collected in a collection plate installed above the flame. The MgO microparticles thus prepared were analyzed with an inductively coupled plasma atomic emission spectrophotometer (ICP-AES, 138 Ultrace, Jobin Yvon Inc.). The result showed that the Mn content was 14 ppm.

### EXAMPLE 2

The procedure of Example 1 was repeated except that the magnesium metal powder was mixed with an Mn metal powder (purity: 99.99%, Sigma Aldrich Co.) to raise the Mn content of the mixture to 2% weight, the resulting mixture being compressed into a pellet. The MgO microparticles thus prepared were analyzed with an ICP-AES. The result showed that the Mn content was 512 ppm.

### TEST EXAMPLE 1

### Characterization of the MgO Microparticles

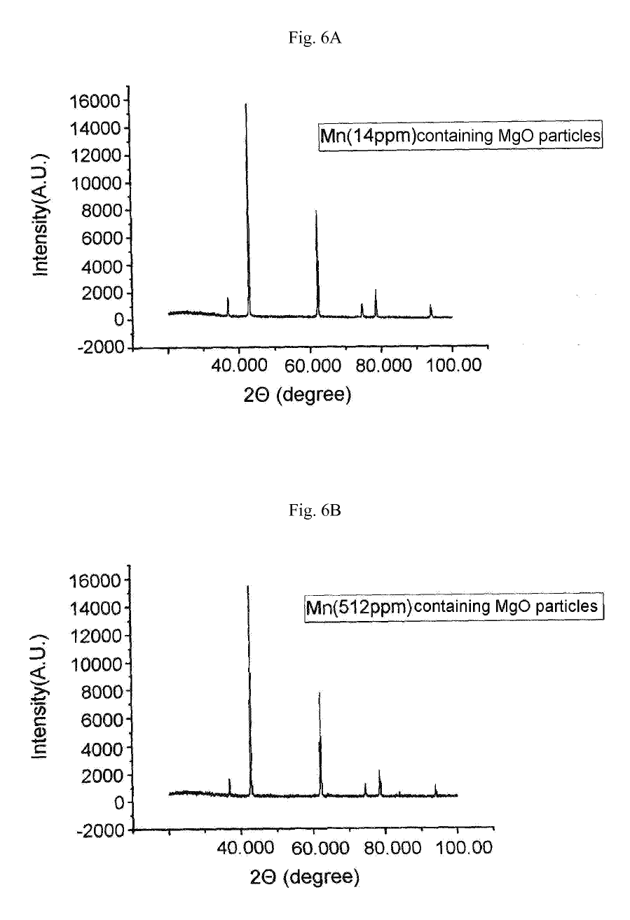

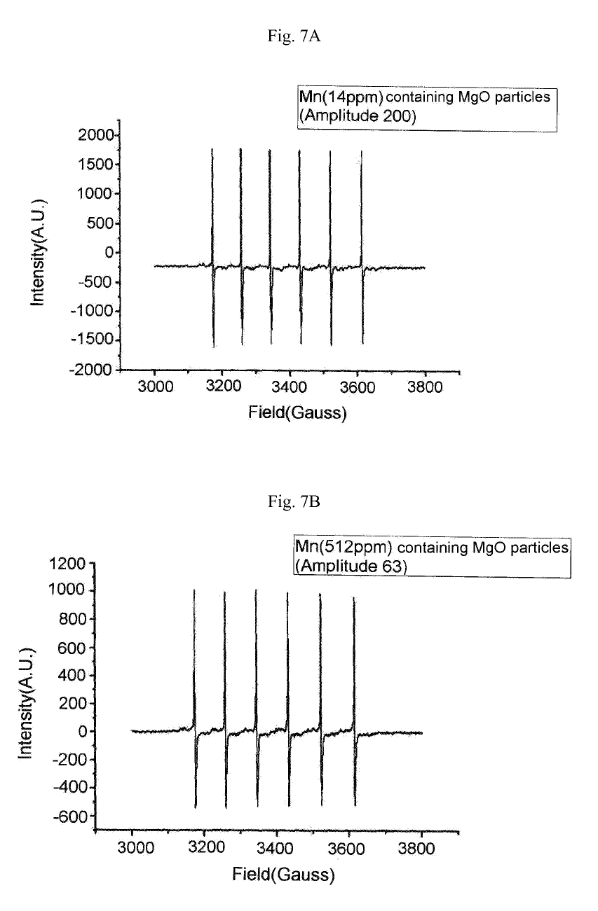

The MgO microparticles obtained in Examples 1 and 2 were subjected to X-Ray Diffraction (XRD) analysis (M18XHF-SRA, MAC Science Co.). As shown in FIGS. 6A and 6B both batches, the MgO microparticles had no trace of residual metal precursor. Further, the inventive MgO microparticles containing 512 ppm of Mn (FIG. 6B) and the MgO microparticles containing 14 ppm of Mn (FIG. 6A) showed identical XRD patterns. Therefore, it was confirmed that the atoms, even when present Mn content was more at a concentration of 512 ppm, are incorporation in the MgO microparticle structure having good crystallinity without forming a separate MnO phase. Further, it was confirmed by electron spin resonance spectrometer (ESR, JES-TE200, JEOL Ltd.) that the Mn atom incorporated in the inventive MgO microparticle in the form of Mn²⁺. As shown in FIGS. 7A and 7B, the MgO microparticles containing 14 ppm Mn (FIG. 7A) and 512 ppm Mn (FIG. 7B) exhibit the presence of 6 Mn²⁺ peaks at the same position.

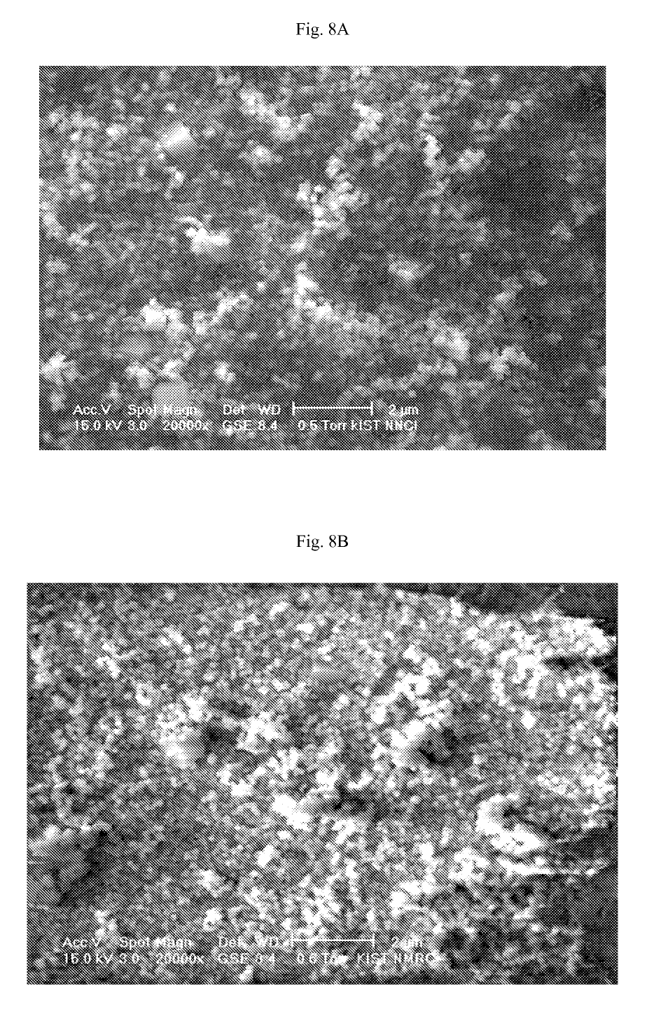

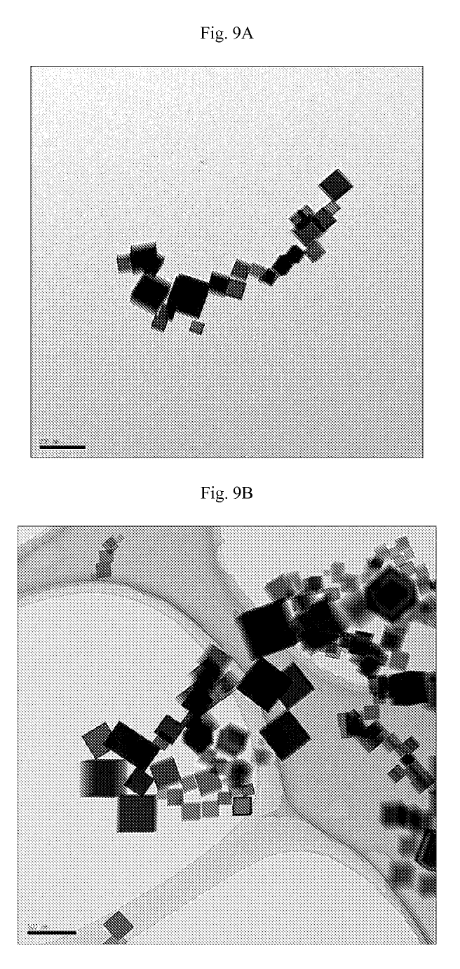

Further, the MgO microparticles thus obtained in Examples were analyzed by scanning electron microscopy (SEM, FEI XL-30 FEG, Philips Inc.) and transmission electron microscopy (TEM, LIBRA 120, Carl Zeiss Inc.). The results are shown in FIGS. 8A and 8B, and 9A and 9B, respectively. As shown in FIGS. 8A and 8B, the MgO microparticles (Mn content: 14 ppm, FIG. 8A) and the MgO microparticles containing a higher Mn content (Mn content: 512 ppm, FIG. 8B) had a perfectly cubic structure. Also, FIGS. 9A and 9B show that the MgO microparticles have a cubic structure and had a diameter distribution between 5 nm and 5 μm regardless of the Mn content.

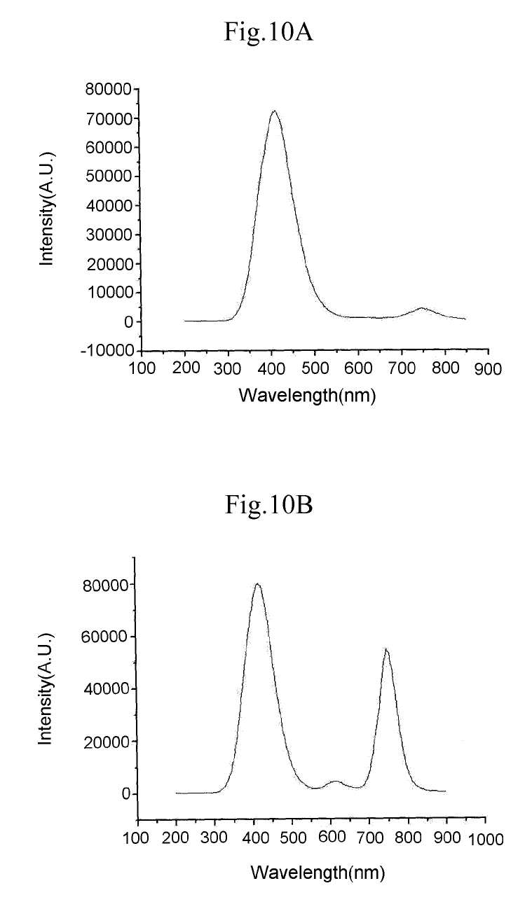

The MgO microparticles were into a pellet and placed in a chamber by scanning electron microscope (ESEM, FEI XL-30 FEG, Philips Inc.) for cathodoluminescence measurement. The cathodoluminescence of the MgO microparticles untreated with other metals was measured by cathodoluminescence detector (Mono-CL, Gatan Inc.), and the results are shown in FIGS. 10A and 10B. As shown in FIG. 10A, the inventive MgO microparticles containing 14 ppm of Mn had peaks around 420 nm and 750 nm, and as shown in FIG. 10B, when the Mn content of the MgO microparticles increased to 512 ppm, the intensities of peaks at 610 nm and 750 nm became highly enhanced. Further, FIGS. 10A and 10B showed no peak within a wavelength of 300 nm or less.

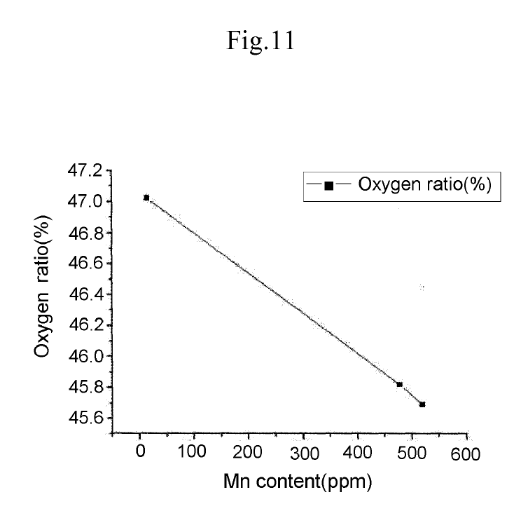

FIG. 11 shows the result of energy-dispersive X-ray spectroscopy (EDX or EDS, Philips Inc.) of the MgO microparticles containing varying amounts of Mn, prepared in Examples. As shown in FIG. 11, as the Mn content increased the oxygen content decreased, suggesting the creation of more oxygen defects.

### TEST EXAMPLE 2

### Performance Test of Discharge Cell Comprising the MgO Microparticle Layer

As shown in FIG. 3, electrode pairs (X, Y) 2 were arranged in a parallel mode on the rear face of the first glass substrate 1 according to a conventional method, and each of the electrode pairs (X, Y) 2 was arranged in a direction parallel to the first glass substrate 1. A dielectric layer 3 was formed on the rear face of the first glass substrate 1 so as to cover the electrode pair (X, Y) 2, and a thin MgO protective layer 4 was formed on the surface of the dielectric layer 3 by deposition or sputtering, followed by uniformly coating thereon the MgO microparticles obtained in Examples in a thickness of about 500 to 700 nm. An SEM photograph of the MgO microparticle layer thus obtained is shown in FIG. 4. The voltage at the start of plasma discharge after a measured voltage was applied to the address electrode of a test device was measured, and the discharge delay time, the time for the discharge is to become stabilized, was measured. The result was compared with that of an existing discharge cell comprising untreated MgO microparticles. The results are shown in Table 1.

TABLE 1

| | | Delay time decreasing rate |
|---|---|---|
| | t_{d} (μs) | $( \frac{{t}_{p} - {t}_{d}}{{t}_{p}} \times 100 ) ( \% )$ |
| Sample A | 1.09 | 52% |
| Sample B | 1.05 | 36% |

* Sample A: a discharge cell coated with the cubic MgO microparticles containing 14 ppm of Mn
Sample B: a discharge cell coated with the MgO microparticles containing 512 ppm of Mn

As can be seen in Table 1, the delay time (t_{d}) of the opposed discharge cell coated with the MgO microparticles having the specific cathodoluminescence characteristic was markedly lower than the delay time (tₚ) observed for the existing discharge cell not coated with the MgO microparticles.

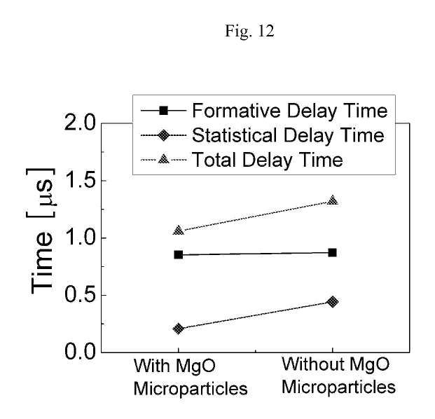

FIG. 12 shows the improvements in the discharge delay time in more detail. When discharge cell was coated with the inventive MgO microparticles containing 14 ppm of Mn, the statistical delay time was markedly shortened by over 50% than the cell having no coated MgO microparticles. The formative delay time was also reduced by 2% when the cell was coated with the inventive MgO microparticles.

Further, the discharge voltages of the Samples A and B decreased by about 3 to 25% as compared with that of the existing discharge cell having no coated MgO microparticles.

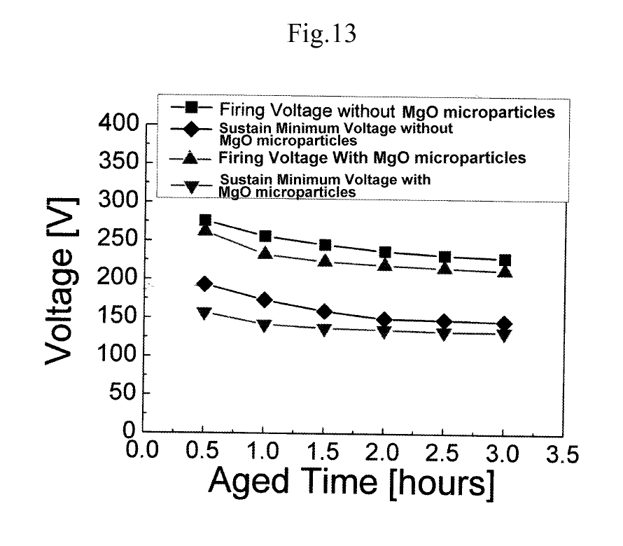

As shown in FIG. 13, firing voltage (Vf) which is the voltage to initiate discharge decreased by about 14 to 24V relative to the firing voltage observed for the cell having no MgO microparticles. The sustain minimum voltage (Vs) which is the minimum voltage necessary to maintain discharging declined by about 13 to 36V relative to that of the cell having no MgO microparticles.

As described above, the inventive plasma producing device comprising magnesium oxide microparticles having the specific cathodoluminescence characteristics exhibit improved discharge characteristics in terms of low discharge voltage and short delay time.

While the invention has been described with respect to the above specific embodiments, it should be recognized that various modifications and changes may be made to the invention by those skilled in the art which also fall within the scope of the invention as defined by the appended claims.

What is claimed is:

1. A plasma producing device comprising:
a first substrate;
at least one first electrode disposed on the surface of the first substrate;
a first dielectric layer formed on the surface of the first substrate, in which the first electrode is embedded;
a second substrate;
at least one second electrode disposed on the surface of the second substrate;
a second dielectric layer formed on the surface of the second substrate, in which the second electrode is embedded; and
partitions positioned between the first and second substrates defining a discharge space between the first and second substrates,
wherein the discharge space comprises magnesium oxide (MgO) microparticles whose cathodoluminescence emission shows no peak at a wavelength of 300 nm or less, but exhibits a peak at a wavelength in the range of 350 to 500 nm as well as at least one peak at wavelengths in the ranges of 550 to 650 nm and 700 to 800 nm when excited by an electron beam.

2. The plasma producing device of claim 1, wherein the MgO microparticles have an average diameter ranging from 5 nm to 5 μm.

3. The plasma producing device of claim 1, wherein the MgO microparticles are disposed on the surface of the first dielectric layer in the form of a layer.

4. The plasma producing device of claim 3, which further comprises a MgO protective layer between the first dielectric layer and the layer of the MgO microparticles.

5. The plasma producing device of claim 1, wherein the discharge space further comprises a phosphor layer, and the MgO microparticles are disposed on the surface of the phosphor layer in the form of a layer.

6. The plasma producing device of claim 1, wherein the discharge space further comprises a phosphor layer in which the MgO microparticles are embedded.

7. The plasma producing device of claim 1, wherein the MgO microparticles are prepared by conducting combustion of a magnesium (Mg) powder or a compound thereof; or combustion of a mixture of a manganese (Mn) powder or a compound thereof and an Mg powder or a compound thereof under an oxygen atmosphere.

8. The plasma producing device of claim 7, wherein the Mn content of the MgO microparticles is in the range of 1 to 1000 ppm.
